(19) United States
(12) Patent Application Publication
(10) Pub. No.: US 2015/0192772 A1
(43) Pub. Date: Jul. 9, 2015

(54) DISPLAY APERTURE PIXEL CIRCUIT ARCHITECTURE INCLUDING PLANARIZATION LAYER

(71) Applicant: Pixtronix, Inc., San Diego, CA (US)

(72) Inventors: Stephen Robert Lewis, Portland, ME (US); Timothy Brosnihan, Natick, MA (US); Ilias Pappas, Burlington, MA (US); George Beebe, Acton, MA (US)

(21) Appl. No.: 14/585,452

(22) Filed: Dec. 30, 2014

Related U.S. Application Data
(60) Provisional application No. 61/924,003, filed on Jan. 6, 2014.

(51) Int. Cl. G02B 26/02; G09G 3/34

(52) U.S. Cl. CPC G02B 26/023; G09G 3/3406; G09G 2320/0233; G09G 2320/0626

(57) ABSTRACT

This disclosure provides systems, methods, and apparatus for providing pixel circuits for controlling the state of operation of light modulators in a display. A pixel circuit used to control one or more display elements of a MEMS display apparatus can include a first output node coupled to a first actuator of a display element and a second output node coupled to a second actuator of the display element. The first output node can be coupled to an actuation interconnect via a first pre-charge switch connected in parallel with a first capacitor. The second output node can be connected to the actuation interconnect via a second pre-charge switch connected in parallel with a second capacitor. Energizing the first output node or the second output node can cause the display element to enter or remain in a first state or a second state, respectively.

### RELATED APPLICATIONS

The present application for patent claims priority to U.S. Provisional Patent Application No. 61/924,003 entitled “DISPLAY APERTURE PIXEL CIRCUIT ARCHITECTURE INCLUDING PLANARIZATION LAYER,” filed Jan. 6, 2014, and assigned to the assignee hereof and hereby expressly incorporated by reference herein.

### TECHNICAL FIELD

This disclosure relates to the field of imaging displays, and in display apparatus backplane architectures and circuits.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

EMS-based display apparatus can include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display apparatus including a plurality of light modulators. The apparatus includes an actuation interconnect for carrying an actuation voltage from one or more drivers to the plurality of light modulators, and a pixel circuit corresponding to each of the light modulators, with each pixel circuit including a first and second actuation node. The first actuation node, when energized, causes a corresponding light modulator to enter or remain in a first state, and the first actuation node is coupled to the actuation interconnect with parallel connections via a first pre-charge switch and via a first capacitor. The second actuation node, when energized, causes the corresponding light modulator to enter or remain in a second state, where the second actuation node is coupled to the actuation interconnect with parallel connections via a second pre-charge switch and via a second capacitor.

In some implementations, the actuation voltage on the actuation interconnect is a switched signal. In some implementations, the apparatus further includes a data storage capacitor for storing a voltage corresponding to image data, where one terminal of the data storage capacitor is connected to the actuation interconnect. In some such implementations, the actuation voltage on the actuation interconnect is substantially constant. Each pixel circuit can include interconnects formed in multiple layers of metal deposited over a substrate. A distance between an upper-most metal layer of the multiple layers of metal is separated from a next nearest metal layer by a planarization layer, which, in some implementations can be thicker than any lower level of dielectric. In some implementations, the planarization layer is between about 1.5 and about 3.5 microns thick. In some implementations, each of the interconnects consumes a respective amount of power. The interconnect that consumes the greatest amount of power is included in the uppermost metal layer of the layer stack.

In some implementations, the apparatus further includes a display, a processor capable of communicating with the display, the processor being capable of processing image data, and a memory device capable of communicating with the processor. In some implementations, the apparatus further includes a driver circuit capable of sending at least one signal to the display and a controller capable of sending at least a portion of the image data to the driver circuit. In some implementations, the apparatus further includes an image source module capable of sending the image data to the processor, where the image source module includes at least one of a receiver, transceiver, and transmitter. In some implementations, the apparatus further includes an input device capable of receiving input data and communicating the input data to the processor.

Another innovative aspect of the subject matter described in this disclosure can be implemented in a method for using a pixel circuit for actuating a light modulator, the light modulator having a shutter configured to move between a first actuator and a second actuator, and the pixel circuit including a first output node coupled to the first actuator and a second output node coupled to the second actuator. The method includes storing a data voltage in a data storage element of the pixel circuit, charging the first output node and the second output node to an actuation voltage, charging a reservoir capacitor coupled to each of the first output node and the second output node, selectively discharging one of the first output node and the second output node based on the data voltage, and providing charge to one of the first output node and the second output node, during an actuation of the light modulator, from the corresponding reservoir capacitor.

In some implementations, storing a data voltage in the data storage element of the pixel circuit includes storing the charge in the data storage element having one terminal maintained at a constant actuation voltage. In some implementations, charging a reservoir capacitor coupled to each of the first output node and the second output node includes charging via an actuation voltage source. In some implementations, providing charge to one of the first output node and the second output node from the corresponding reservoir capacitor includes balancing a capacitive coupling between the first output node and the second output node.

Another innovative aspect of the subject matter described in this disclosure can be implemented in an apparatus including a pixel circuit for actuating a light modulator having a shutter configured to move between a first actuator and a second actuator. The apparatus includes data storage means for storing a data voltage, charging means for charging a first output node and a second output node of the pixel circuit to an actuation voltage, the first output node and the second output node coupled to the first actuator and a second actuator, respectively, discharging means for selectively discharging one of the first output node and the second output node, and reservoir charge storage means for providing charge to one of the first output node and the second output node during an actuation of the light modulator.

In some implementations, the data storage means include a data storage capacitor, one terminal of which is maintained at a constant actuation voltage. In some implementations, the data storage means include a data storage capacitor, one terminal of which is maintained at a voltage equal to a voltage on the shutter. In some implementations, the reservoir charge storage means are coupled to a voltage source providing the actuation voltage.

### BRIEF DESCRIPTION OF THE DRAWINGS

Figure lA shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a first example pixel circuit that can be implemented for controlling a light modulator.

FIG. 4 is a flow diagram of an example process of driving the pixel circuit shown in FIG. 3.

FIG. 5 is an example timing diagram corresponding to the driving process shown in FIG. 4.

FIG. 6 shows another example pixel circuit that can be implemented for controlling a light modulator.

FIG. 7 is a flow diagram of an example process for driving the pixel circuit shown in FIG. 6.

FIG. 8 is an example timing diagram corresponding to the driving process shown in FIG. 7.

FIG. 9 is a cross-sectional diagram of an example schematic of the control matrix.

FIG. 10 is a flow diagram of an example process for fabricating a display apparatus.

FIGS. 11A and 11B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Pixel circuits used to control display elements of MEMS display apparatus can be highly sensitive to the capacitances built into the circuits. In some implementations, to improve the stability of the operation of the pixel circuits, additional capacitances can be added to pixel circuits. Additional capacitances can be provided by intentionally routing certain otherwise extant interconnects deposited on different metal layers of the backplane to crossover one another. Capacitance also can be added by forming explicit capacitor structures in which conductors are patterned into the metal layers for the sole purpose of overlapping conductors in other metal layers, thereby forming a capacitor. For example, in some implementations, explicit capacitors can be added to a pixel circuit between an actuation voltage interconnect and one or more output nodes of the pixel circuit. In some implementations, a data storage capacitor used for storing a data voltage corresponding to image data can be coupled between an input node of the pixel circuit and the actuation voltage interconnect, where the actuation voltage interconnect is maintained at a constant actuation voltage.

Particular implementations of the subject matter described in this disclosure can be implemented to realize one or more of the following potential advantages. Careful planning of capacitances in a pixel circuit can increase the reliability of the circuit operation. At the same time reducing unwanted parasitic capacitances by spacing metal layers further apart can reduce power consumption. The use of a planarization layer instead of a conformal dielectric layer has the added benefit of providing a smooth, flat surface on which MEMS structures can be fabricated, improving yield. By including explicit capacitors coupled to the actuators of a light modulator, reduction in voltage at the actuators during actuation can be minimized, thereby improving the speed of actuation of the actuators. Explicit capacitors also can serve to balance capacitive coupling between output nodes of the pixel circuit and thereby improve the stability of the pixel circuit. In some implementations, one terminal of a data storage capacitor, used for storing data voltages corresponding to image data, is coupled to a shutter interconnect. This can result in power losses during polarity inversion or reversal. By connecting the terminal of the data storage capacitor to a constant actuation voltage source can reduce power losses within the data capacitor during polarity inversion or reversal.

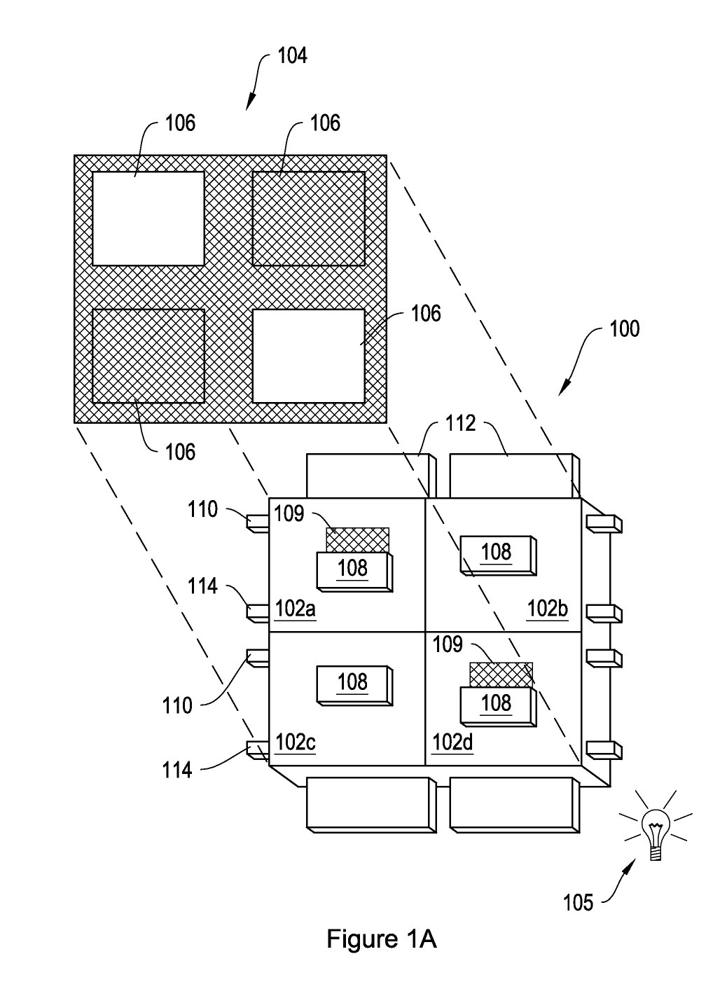

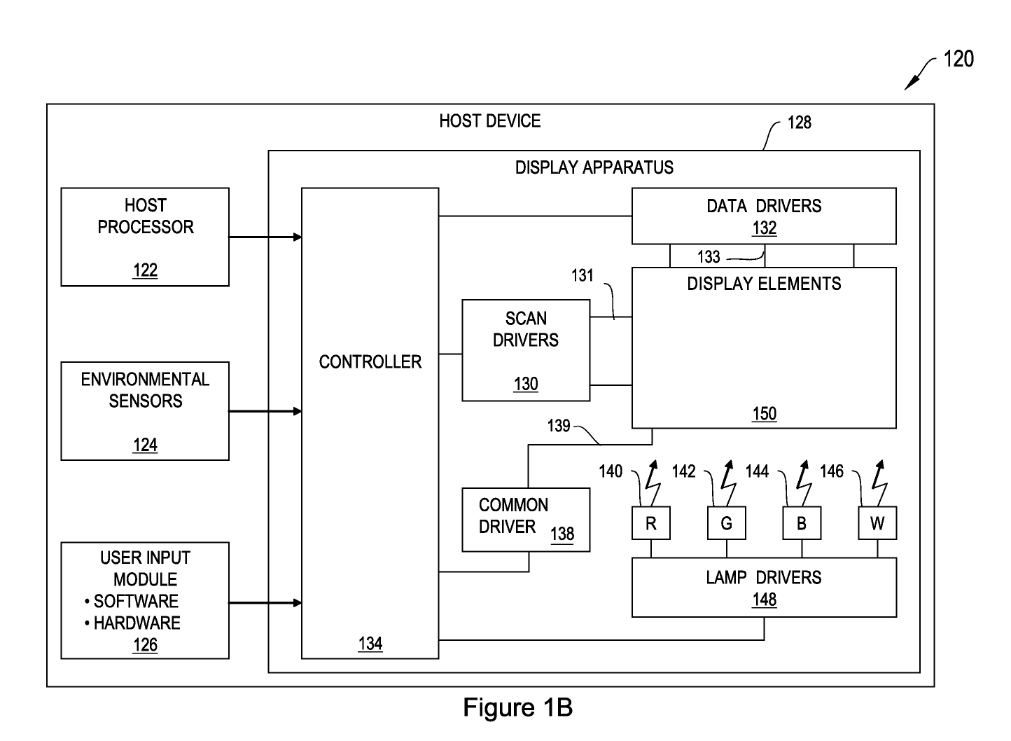

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

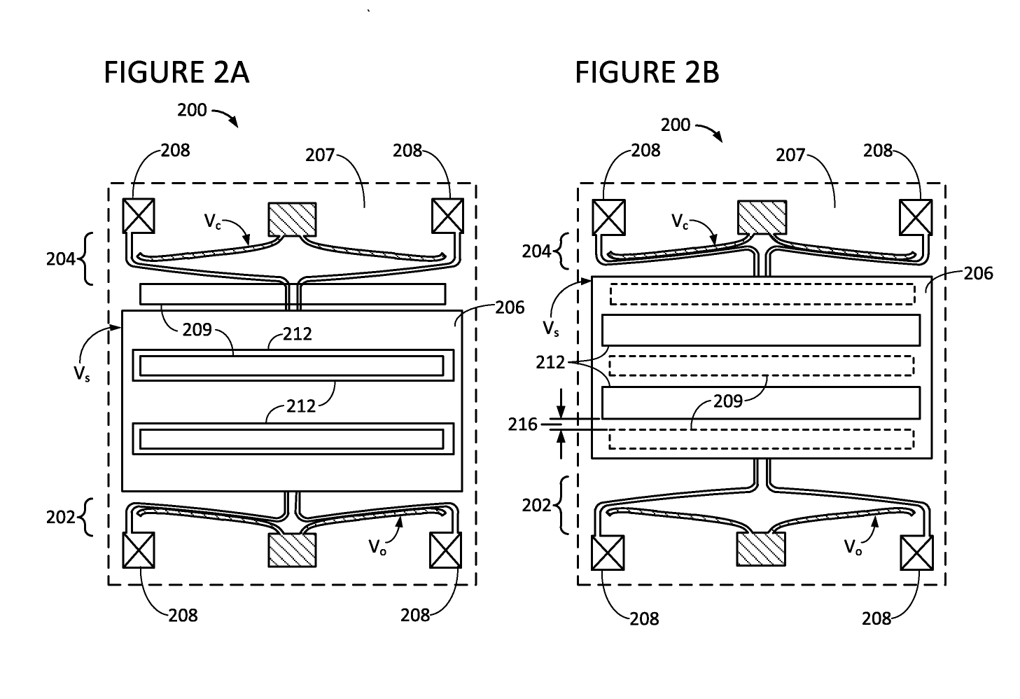

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

Electrical bi-stability in electrostatic actuators, such as actuators 202 and 204, can arise from the fact that the electrostatic force across an actuator is a function of position as well as voltage. The beams of the actuators in the shutter assembly 200 can be implemented to act as capacitor plates. The force between capacitor plates is proportional to 1/d² where d is the local separation distance between capacitor plates. When the actuator is in a closed state, the local separation between the actuator beams is very small. Thus, the application of a small voltage can result in a relatively strong force between the actuator beams of the actuator in the closed state. As a result, a relatively small voltage, such as Vₘ, can keep the actuator in the closed state, even if other elements exert an opposing force on the actuator.

In dual-actuator light modulators, the equilibrium position of the light modulator can be determined by the combined effect of the voltage differences across each of the actuators. In other words, the electrical potentials of the three terminals, namely, the shutter open drive beam, the shutter close drive beam, and the load beams, as well as modulator position, can be considered to determine the equilibrium forces on the modulator.

For an electrically bi-stable system, a set of logic rules can describe the stable states and can be used to develop reliable addressing or digital control schemes for a given light modulator. Referring to the shutter assembly 200 as an example, these logic rules are as follows:

Let Vₛ be the electrical potential on the shutter or load beam. Let Vₒ be the electrical potential on the shutter-open drive beam. Let V_{c} be the electrical potential on the shutter-close drive beam. Let the expression |Vₒ−Vₛ| refer to the absolute value of the voltage difference between the shutter and the shutter-open drive beam. Let Vₘ be the maintenance voltage. Let Vₐₜ be the actuation threshold voltage, i.e., the voltage to actuate an actuator absent the application of Vₘ to an opposing drive beam. Let Vₘₐₓ be the maximum allowable potential for Vₒ and V_{c}. Let Vₘ<Vₐₜ<Vₘₐₓ. Then, assuming Vₒ and V_{c} remain below Vₘₐₓ:

If |Vₒ−Vₛ|<Vₘ and |V_{c}−Vₛ|<Vₘ (rule 1)

Then the shutter will relax to the equilibrium position of its mechanical spring.

If |Vₒ−Vₛ|>Vₘ and |V_{c}−Vₛ|>Vₘ (rule 2)

Then the shutter will not move, i.e., it will hold in either the open or the closed state, whichever position was established by the last actuation event.

If |Vₒ−Vₛ|>Vₐₜ and |V_{c}−Vₛ|<Vₘ (rule 3)

Then the shutter will move into the open position.

If |Vₒ−Vₛ|<Vₘ and |V_{c}−Vₛ|>Vₐₜ (rule 4)

Then the shutter will move into the closed position.

Following rule 1, with voltage differences on each actuator near zero, the shutter will relax. In many shutter assemblies, the mechanically relaxed position is partially open or closed, and so this voltage condition is usually avoided in an addressing scheme.

The condition of rule 2 makes it possible to include a global actuation function into an addressing scheme. By maintaining a shutter voltage which provides beam voltage differences that are at least the maintenance voltage, Vₘ, the absolute values of the shutter open and shutter closed potentials can be altered or switched in the midst of an addressing sequence over wide voltage ranges (even where voltage differences exceed Vₐₜ) with no danger of unintentional shutter motion.

The conditions of rules 3 and 4 are those that are generally targeted during the addressing sequence to ensure the bi-stable actuation of the shutter.

The maintenance voltage difference, Vₘ, can be designed or expressed as a certain fraction of the actuation threshold voltage, Vₐₜ. For systems designed for a useful degree of bi-stability, the maintenance voltage can exist in a range between about 20% and about 80% of Vₐₜ. This helps ensure that charge leakage or parasitic voltage fluctuations in the system do not result in a deviation of a set holding voltage out of its maintenance range—a deviation which could result in the unintentional actuation of a shutter. In some systems, an exceptional degree of bi-stability or hysteresis can be provided, with Vₘ existing over a range of about 2% and about 98% of Vₐₜ. In these systems, however, care must be taken to ensure that an electrode voltage condition of |V_{c}−Vₛ| or |Vₒ−Vₛ| being less than Vₘ, can be reliably obtained within the addressing and actuation time available.

In some implementations, the first and second actuators of each light modulator are coupled to a latch or a drive circuit to ensure that the first and second states of the light modulator are the two stable states that the light modulator can assume.

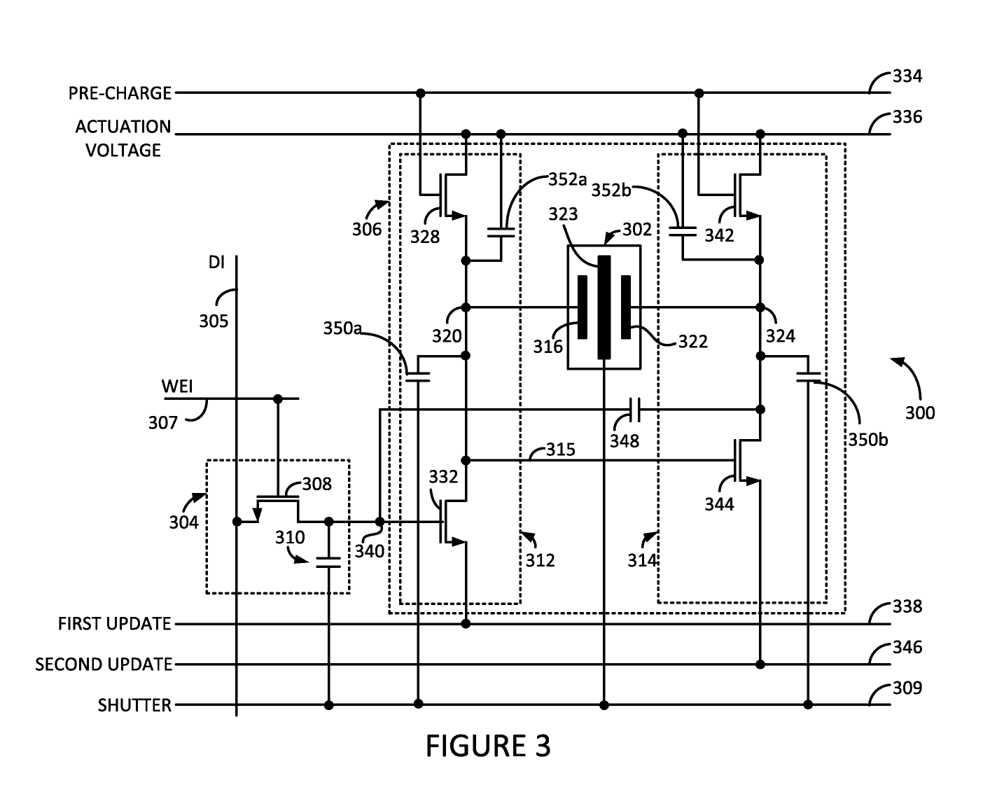

FIG. 3 shows a first example pixel circuit 300 that can be implemented for controlling a light modulator 302. In particular, the pixel circuit 300 can be used to control dual actuator light modulators, such as the light modulator 200 shown in FIGS. 2A and 2B. The pixel circuit 300 can be part of a control matrix that controls an array of pixels that incorporate light modulators similar to the light modulator 302.

The pixel circuit 300 includes a data loading circuit 304 coupled to an actuation circuit 306. The data loading circuit 304 receives and stores data associated with the pixel, while the actuation circuit 306 actuates the light modulator 302 based on the data stored by the data loading circuit 304. In some implementations, various components of the pixel circuit 300 can be implemented using TFTs. In some implementations, TFTs manufactured using materials such as amorphous-silicon (a-Si), indium-gallium-zinc-oxide (IGZO), other semiconducting metal oxides, or polycrystalline-silicon may be used. In some other implementations, various components of the pixel circuit 300 are implemented using MOSFETs. As will be readily understood by a person having ordinary skill in the art, TFTs are three terminal transistors having a gate terminal, source terminal, and a drain terminal. The gate terminal can act as a control terminal such that a voltage applied to the gate terminal in relation to the source terminal can switch the TFT ON or OFF. In the ON state, the TFT allows electrical current flow from the source terminal to the drain terminal. In the OFF state, the TFT substantially blocks any current flow from the source to the drain. The implementation of the pixel circuit 300, however, is not limited to TFTs or MOSFETS, and other transistors such as bipolar junction transistors also may be utilized.

As mentioned above, the data loading circuit 304 is used to load data associated with the pixel. Specifically, the data loading circuit 304 is coupled to a data interconnect (DI) 305, which is common to all the pixels in the same column of the array of pixels. The data interconnect 305 is energized with a data voltage corresponding to the data to be loaded into the pixel. In some implementations, the data voltage can be a voltage between a minimum data voltage, such as ground, and a maximum data voltage, as well as a voltage at those limits. In some implementations, the data to be loaded into the pixel can be a pixel intensity value. In some implementations, the pixel intensity value can be related to the data voltage. That is, the pixel intensity is a function of the magnitude of the data voltage.

The data loading circuit 304 is also coupled to a write enabling interconnect (WEI) 307, which is common to all pixels in the same row of the array as the pixel associated with the pixel circuit 300. When the write enabling interconnect 307 is energized with a write enabling voltage, the data loading circuit 304 accepts data provided on the data interconnect 305.

To accomplish the data loading function, the data loading circuit 304 includes a write enabling transistor 308 and a data storage capacitor 310. The write enabling transistor 308 can be a controllable transistor switch, the operation of which can be controlled by the write enabling voltage on the write enabling interconnect 307. The gate terminal of the write enabling transistor 308 can be coupled to the write enabling interconnect 307. A first source/drain terminal of the write enabling transistor 308 can be coupled to the data interconnect 305, while the second source/drain terminal can be coupled to a data storage capacitor 310. The data storage capacitor 310 can be used to store the data voltage that is representative of the data provided by the data interconnect 305. One terminal of the data storage capacitor 310 is coupled to the write enabling transistor 308, while the other terminal of the data storage capacitor 310 is coupled to a shutter interconnect (SHUTTER) 309. The shutter interconnect 309 provides a common reference voltage such as ground, or some other selected reference voltage, to pixels in multiple rows and columns of the display apparatus.

As mentioned above, the data loading circuit 304 is coupled to the actuation circuit 306. Specifically, the data storage capacitor 310 is coupled to a first actuation sub-circuit 312. The actuation circuit 306 also includes a second actuation sub-circuit 314 coupled to the first actuation sub-circuit 312 via a sub-circuit interconnect 315. The first actuation sub-circuit 312 governs a first output voltage supplied to a first actuator 316 of the light modulator 302. The first actuation sub-circuit 312 is coupled to the first actuator 316 via a first output node (Out₁) 320. The second actuation sub-circuit 314 governs a second output voltage supplied to a second actuator 322 of the light modulator 302. The second actuation sub-circuit 314 is coupled to the second actuator 322 via a second output node (Out₂) 324.

The light modulator 302 also includes a shutter terminal 323, which is connected to the shutter interconnect 309. A shutter voltage, similar to the shutter voltage Vₛ discussed above in relation to the shutter assembly 200 shown in FIGS. 2A and 2B, can be provided to the shutter terminal 323 of the light modulator 302 via the shutter interconnect 309. In some implementations, applying a voltage V_{QUT1} to the first actuator 316 via the first output node 320 and applying a voltage V_{OUT2} to the second actuator 322 via the second output node 324 such that |V_{OUT1}−Vₛ|>Vₐₜ and |V_{OUT2}−Vₛ|<Vₘ the shutter 323 will move to an OPEN state (as described in rule 3 discussed above in relation to FIGS. 2A and 2B), where Vₐₜ is the actuation threshold voltage and Vₘ is the maintenance voltage. Conversely, if |V_{OUT2}−Vₛ|>Vₐₜ and |V_{OUT1}−Vₛ|<Vₘ, the shutter 323 will move to the CLOSED state (see rule 4 discussed above).

The first actuation sub-circuit 312 controls the voltage at the first output node 320 by appropriately charging and discharging the first output node 320. Specifically, the first actuation sub-circuit 312 includes a charging path and a discharging path coupled to the first output node 320. The charging path includes a first pre-charge transistor 328 and the discharging path includes a first discharge transistor 332. The first pre-charge transistor 328 is controlled by a pre-charge interconnect (PCH) 334 to selectively allow current to flow from an actuation voltage interconnect (ACT) 336, which is maintained at an actuation voltage, to the first output node 320. In some implementations, the first pre-charge transistor 328 can be an n-type TFT. In such an implementation, when a pre-charge voltage is applied to the pre-charge interconnect 334, the first pre-charge transistor 328 switches ON and allows the first output node 320 to be charged to a voltage that is substantially equal to the actuation voltage on the actuation voltage interconnect 336. When the pre-charge voltage is removed from the pre-charge interconnect 334, the first pre-charge transistor 328 switches OFF and isolates the first output node 320 from the voltage on the actuation voltage interconnect 336.

The drain terminal of the first discharge transistor 332 is coupled to the first output node 320, while the source terminal of the first discharge transistor 332 is coupled to a first update interconnect 338. The gate terminal of the first discharge transistor 332 is coupled to the data storage capacitor 310 at input node 340. Thus, based on the voltages at the data storage capacitor 310 and the first update interconnect 338, the first discharge transistor 332 can selectively discharge the voltage at the first output node 320.

The voltage on the first update interconnect 338 can serve as a gating signal to control the timing of the response of the first discharge transistor 332 to the voltage stored on the data storage capacitor 310. For example, if the voltage on the first update interconnect 338 is high, then the first discharge transistor 332 is prevented from switching ON irrespective of the voltage across the data storage capacitor 310. However, when the voltage on the first update interconnect 338 is brought low, then the first discharge transistor 332 will switch ON or OFF based on the data voltage stored on the data storage capacitor 310. That is, if the data voltage on the data storage capacitor 310 is high, then the first discharge transistor 332 switches ON and discharges the voltage on the first output node 320; however, if the data voltage on the data storage capacitor 310 is low, then the first discharge transistor 332 remains switched OFF and does not discharge the first output node 320. In some implementations, the first discharge transistor 332 can be an n-type TFT.

The second actuation sub-circuit 314 is coupled to the second actuator 322 via the second output node 324. The second actuation sub-circuit 314 is used to control the voltage at the second output node 324 by selectively charging and discharging the second output node 324. In particular, the second actuation sub-circuit 314 operates such that the voltage at the second output node 324 (coupled to the second actuator 322) is an inverse of the voltage on the first output node 320 (coupled to the first actuator 316). For example, if the voltage on the first output node 320 is high, the second actuation sub-circuit 314 discharges the second output node 324 to a low voltage. On the other hand if the voltage on the first output node 30 is low, the second actuation sub-circuit 314 retains the high voltage applied to the second output node 324 during the pre-charge operations described above.

Similar to the first actuation sub-circuit 312, the second actuation sub-circuit 314 also includes a charge path and a discharge path. The charge and discharge paths are used for charging and discharging the second output node 324. The charge path includes a second pre-charge transistor 342 and the discharge path includes a second discharge transistor 344. A first source/drain terminal of the second pre-charge transistor 342 is coupled to the actuation voltage interconnect 336, while a second source/drain terminal is coupled to the second output node 324. The gate terminal of the second pre-charge transistor 342 is coupled to the pre-charge interconnect 334. When the pre-charge voltage is applied to the pre-charge interconnect 334, the second pre-charge transistor 342 is switched ON causing the second output node 324 to be charged to the actuation voltage.

The gate terminal of the second discharge transistor 344 is coupled to the first output node 320. While the source and drain terminals of the second discharge transistor 344 are coupled to a second update interconnect 346 and the second output node 324, respectively. The voltage on the second update interconnect 346 is used to control the response of the second actuation sub-circuit 314 to the voltage on the first output node 320. For example, if the voltage on the second update interconnect 346 is high enough, the second discharge transistor 344 would remain OFF regardless of the voltage at the first output node 320. However, when the voltage on the second update interconnect 346 is brought low, the second discharge transistor 344 switches ON or OFF based on the voltage on the first output node 320. For example, if the first output node 320 is at the actuation voltage, then the second discharge transistor 344 switches ON and discharges the second output node 324 to the voltage on the second update interconnect 346; and if the voltage on the first output node 320 is low, then the second discharge transistor 344 remains switched OFF and maintains the voltage at the second output node 324 at the actuation voltage.

The pixel circuit 300 also includes a compensation capacitor 348 coupled at the input node 340 between the data storage capacitor 310 and the second output node 324. The compensation capacitor 348 compensates for any undesirable loss of charge from the data storage capacitor 310 that may occur due to the presence of parasitics within the pixel circuit 300. In particular, parasitic gate-to-drain capacitor of the first discharge transistor 332, in some conditions, can cause partial or complete discharge of the data storage capacitor 310. In some instances, interconnect parasitics, separately or in addition to the parasitic gate-to-drain capacitor, also may cause discharge of the data storage capacitor 310. The compensation capacitor 348 provides a path for charge to flow form the second output node 324 into the data storage capacitor 310 when the second output node 324 is pre-charged. Specifically, when the voltage on the pre-charge interconnect 334 is increased, the second pre-charge transistor 342 is switched ON. This causes the voltage at the second output node 324 to rapidly increase to the actuation voltage. This rapid rise in voltage at the second output node 324 causes the compensation capacitor 348 and the data storage capacitor 310 to conduct. A current path can be formed from the second output node 324 to the shutter interconnect 309 via the compensation capacitor 348 and the data storage capacitor 310. This causes charge injection into the data storage capacitor 310. As discussed below in describing the operation of the pixel circuit 300, this charge injection compensates for the loss of charge, due to parasitics, from the data storage capacitor 310 such that the data storage capacitor 310 can be maintained at or above desirable voltage levels.

The amount of charge injection into the data storage capacitor 310 can depend upon the size of the compensation capacitor 348. In some implementations, the compensation capacitor 348 can have a capacitance value that is substantially equal to the gate-to-drain capacitance of the first discharge transistor 332. In some other implementations, the compensation capacitor 348 can have a capacitance value that is substantially equal to the gate-to-drain capacitance of the first discharge transistor 332 in addition to the capacitance of any interconnects utilized to form and connect the compensation capacitor 348. In some other implementations, the compensation capacitor 348 can have a capacitance value of between about 5 and 15 femto-farads, or 8 and about 12 femto-farads. In some implementations, the compensation capacitor 348 can have a capacitance value of about 10 femto-farads. In some implementations, the compensation capacitor 348 is formed from overlapping portions of two adjacent metal layers, where the overlapping portions are at greater in size than the minimum feature size allowed by the fabrication technology in which the compensation capacitor 348 is manufactured.

In addition to the compensation capacitor 348, the pixel circuit can have additional intentional capacitances coupled to the actuation circuit 306. The additional capacitances can take two forms. A first type of added capacitance is referred to herein as an intentional routing capacitance. The control matrix is formed from interconnects dispersed across three metal layers separated by dielectric layers and coupled by vias. Intentional routing capacitances are formed from the intentional routing of various interconnects on different metal layers so that they cross over one another. Such interconnect crossing results in an increased capacitance. In some implementations, the shape and dimensions of the interconnects at the cross-over points can be designed to create a specific desired capacitance. The second form of added capacitance is referred to herein as explicit capacitors. An explicit capacitor is formed by portions of a circuit that would not exist other than to form the capacitor, in contrast to forming a capacitance by routing an otherwise extant circuit line to cross over another extant circuit line. The compensation capacitor 348 and data storage capacitor 310 are examples of explicit capacitors.

FIG. 3 includes both additional intentional routing capacitances 350a and 350b, as well as additional explicit capacitors 352a and 352b, each having capacitances ranging from about 20 femto-farads to about 75 femto-farads. Together these additional capacitances serve to stabilize the operation of the light modulator controlled by the pixel circuit 300, during its actuation. For example, in the pixel circuit 300, when the shutter changes state, it is no longer directly coupled to a powered actuation voltage line, as the first and second output nodes 320 and 324 are both isolated (other than through the explicit capacitors 352a and 352b) from the actuation interconnect by the first and second pre-charge switches 328 and 342. As the shutter moves, the distance between energized actuator electrodes decreases, decreasing the capacitance and electric field across the actuator electrodes. Unless additional charge is available for injection on to the actuator electrodes, the voltage across the actuator can decrease, slowing actuation. The intentional routing capacitances 350a and 350b and the explicit capacitors 352a and 352b serve as charge reservoirs for such instances. The explicit capacitors 352a and 352b also serve to balance the capacitive coupling between the first and second output nodes 320 and 324 and the other interconnects of the pixel circuit 300. In some implementations, the explicit capacitors 352a and 352b can have the same capacitance values. In some other implementations, the capacitance values of the explicit capacitors 352a and 352b can be different and can be tuned specifically to balance the capacitive coupling between the first and second output nodes 320 and 324 and the other interconnects of the pixel circuit 300.

The intentional routing capacitances 350a and 350b are formed from portions of the shutter interconnect 309 crossing over portions of the interconnects coupling the source/drain terminals of the first and second discharge switches 332 and 334 with the first and second pre-charge switches 328 and 342. The explicit capacitors 352a and 352b are formed with one terminal of each capacitor 352a and 352b coupling to the actuation voltage interconnect 336 and the other coupling interconnects coupling to the first and second output nodes 320 and 324.

In some implementations, the additional intentional routing capacitances 350a and 350b also can be useful when the pixel circuit operation includes switching the voltage on the actuation interconnect 336 between high and low voltages, as described further below. In such implementations, the intentional routing capacitances 350a and 350b help prevent voltage drops across the first and second pre-charge switches 328 and 342, when the voltage on the actuation voltage interconnect 336 is brought low.

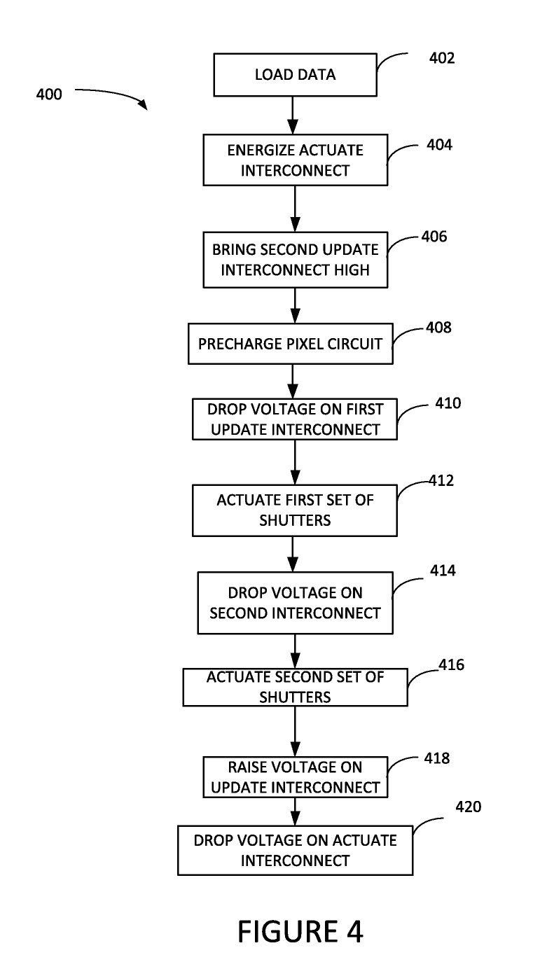

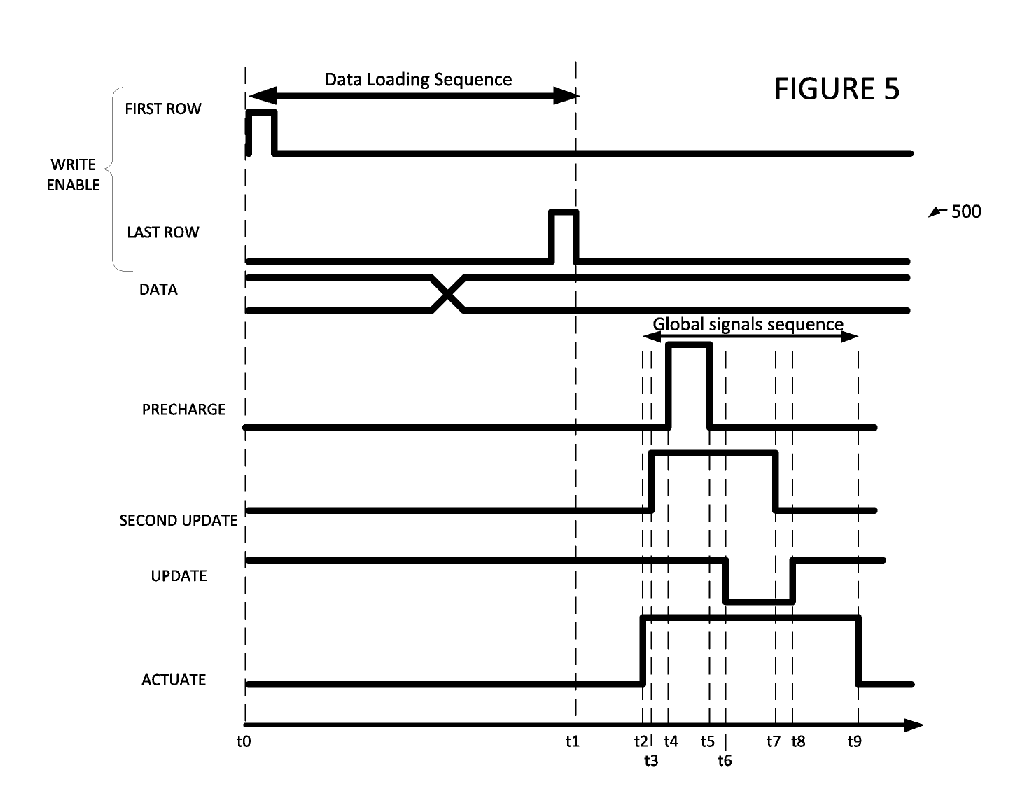

FIG. 4 is a flow diagram of an example process 400 of driving the pixel circuit 300 shown in FIG. 3. FIG. 5 is an example timing diagram 500 corresponding to the driving process 400 shown in FIG. 4. Referring to FIGS. 3-5, the driving process 400 begins with loading data into the pixel circuits 300 of a display apparatus (stage 402), one row at a time, while the first update interconnect 338 is maintained at a high voltage and the voltages on the other common interconnects 334, 336, 338, 346 and 309 are kept low. An example data loading stage is shown from times t0 to t1 on the timing diagram 500. After data is loaded into the last row of the display at time t1, at time t2, the actuation voltage interconnect 336 is energized (stage 404), bringing the voltage on the actuation voltage interconnect 336 up to an actuation voltage.

The second update interconnect 346 is then brought high at time t3, preventing the second discharge switch 344 from being triggered prematurely (stage 406). A high voltage is then applied to the pre-charge interconnect 334 for a brief period of time (from time t4 to time t5) sufficient to bring the first and second output nodes 320 and 324 up to about the actuation voltage (less the threshold voltages of the first and second pre-charge switches 328 and 342) (stage 408).

The voltage on the first update interconnect 338 is then brought low at time t6, allowing the first discharge switch 332 to respond to the data voltage on the data store capacitor 310 (stage 410). A high voltage on the data store capacitor 310 turns on the first discharge switch 332, draining any voltage built up on the first update node 320. A low voltage on the data store capacitor 310 keeps the first discharge switch 332 off, maintaining about the actuation voltage on the first output node 320. At this stage, the voltage on the second output node 324 is still high, resulting in a first set of shutters actuating (stage 412). Specifically, all shutters that were previously drawn to the first output node 320 but for which the voltage on the first output node 320 has now drained, will be pulled toward the second output node 324.

After a sufficient amount of time has passed to allow the voltage to drain from the first output node 320 through the first discharge switch 332, at time t7 the voltage on the second update interconnect 346 is brought low (stage 414), allowing the second discharge switch 344 to be controlled by the voltage remaining on the first output node 320. If the voltage on the first output node 320 is low, the second discharge switch 344 remains off, maintaining the actuation voltage on the second output node 324. If the voltage on the first output node 320 is high, the second discharge switch 344 turns on, releasing the voltage stored on the second output node 324. As a result, a second set of shutters actuate (stage 416). Specifically those shutters previously attracted to the second output node 324, but for which the voltage on the second output node 324 has now been released, are now free to be drawn towards the first output node 320.

The voltage on the first update interconnect 338 is then raised again at time t8 (stage 418), preserving the states of the shutters until after the next data loading stage (stage 402). The voltage on the actuation voltage interconnect 336 can then be dropped (stage 420), as well, at time t9.

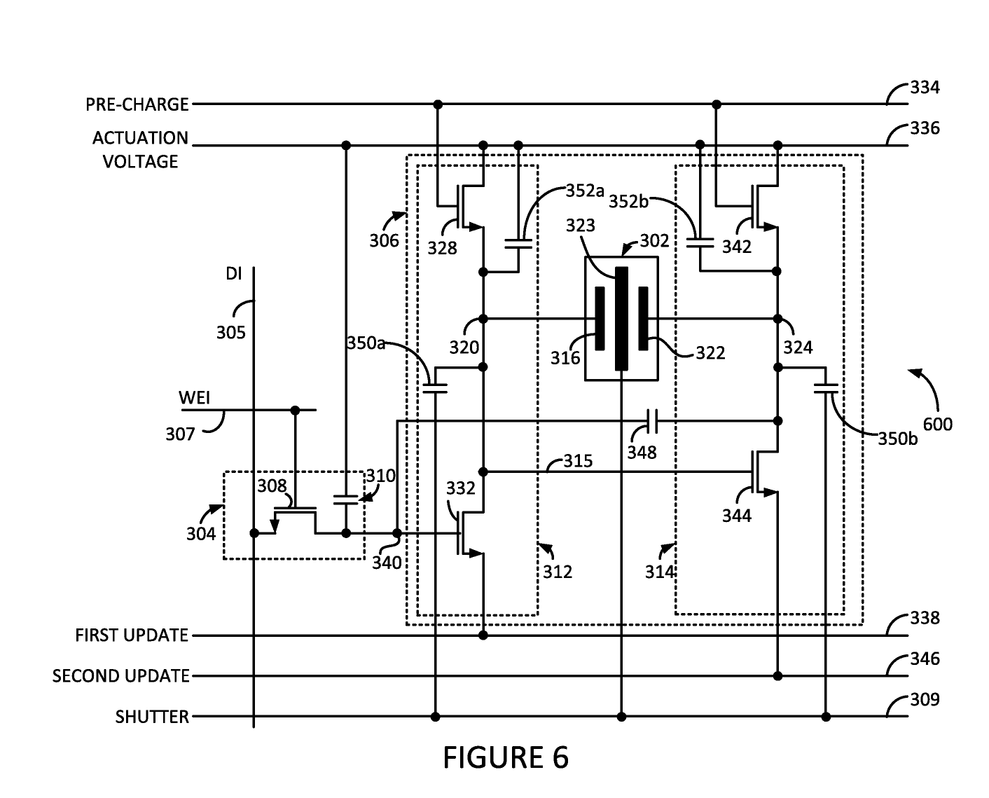

FIG. 6 shows another example pixel circuit 600 that can be implemented for controlling a light modulator 302. In particular, the pixel circuit 600 can be used to control dual actuator light modulators, such as the light modulator 200 shown in FIGS. 2A and 2B. The pixel circuit 600 can be part of a control matrix that controls an array of pixels that incorporate light modulators similar to the light modulator 302.

The pixel circuit 600 is similar to the pixel circuit 300 shown in FIG. 3. However, unlike the pixel circuit 300, which includes a data storage capacitor 310 connected between the input node 340 and the shutter interconnect 309, the pixel circuit 600 includes a data storage capacitor 310 that is connected between the input node 340 and the actuation interconnect 336. Further, the actuation interconnect 336 can be maintained at a substantially constant actuation voltage.

The data loading function in the pixel circuit 600 is accomplished in a manner similar to that in the pixel circuit 300. For example, when the write enabling interconnect 307 is energized, the write enabling transistor 308 is switched ON. This causes the input node 340 to be substantially equal to the data voltage V_{d} appearing on the data interconnect 305. Thus, the data storage capacitor 310 is charged or discharged in accordance with the data voltage. For example, if the data voltage is about 0 V, then the terminal of the data storage capacitor 310 connected to the input node 340 is maintained at 0 V, while the other terminal connected to the actuation interconnect 336 is maintained at an actuation voltage (V_{ACT}). As a result, after the write enabling transistor 308 is switched OFF, the data storage capacitor 310 stores a voltage of V_{ACT} to provide a data voltage of 0 V to the input node. Similarly, if the data voltage is about 5 V, then the data storage capacitor is charged or discharged such that the voltage drop across the capacitor is about V_{ACT}−5 V. Generally, the voltage drop across the data storage capacitor 310 is equal to about V_{ACT}−V_{d} resulting in a voltage equal to the data voltage V_{d} appearing at the input node 340.

In some implementations, where polarity reversal or inversion is employed to reduce charge buildup over the actuators of the light modulator 302, connecting the data storage capacitor 310 between the input node 340 and the shutter interconnect 309 (an example of which is shown in FIG. 3) may result in power losses. For example, during polarity inversion the voltage at the shutter interconnect 309 may be switched between a ground voltage in some image frame periods and an actuation voltage in other image frame periods. If the data storage capacitor is connected between the input node 340 and the shutter interconnect 309, these changes in the voltage levels on the shutter interconnect 309 may result in current flow through the data storage capacitor 310. The current flow through the data storage capacitor 310 may in turn result in power losses.

By connecting the data storage capacitor 310 between the input node 340 and the actuation interconnect 336, which is maintained at a substantially constant actuation voltage, current flow through the data capacitor, and the resulting power losses, during polarity inversion or reversal can be avoided. As a result, the power losses associated with the pixel circuit 600 can be reduced.

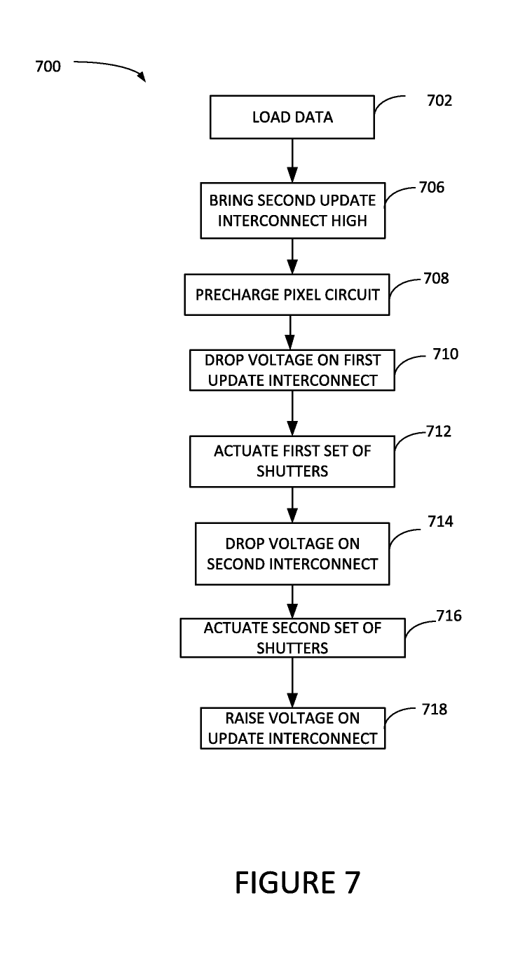

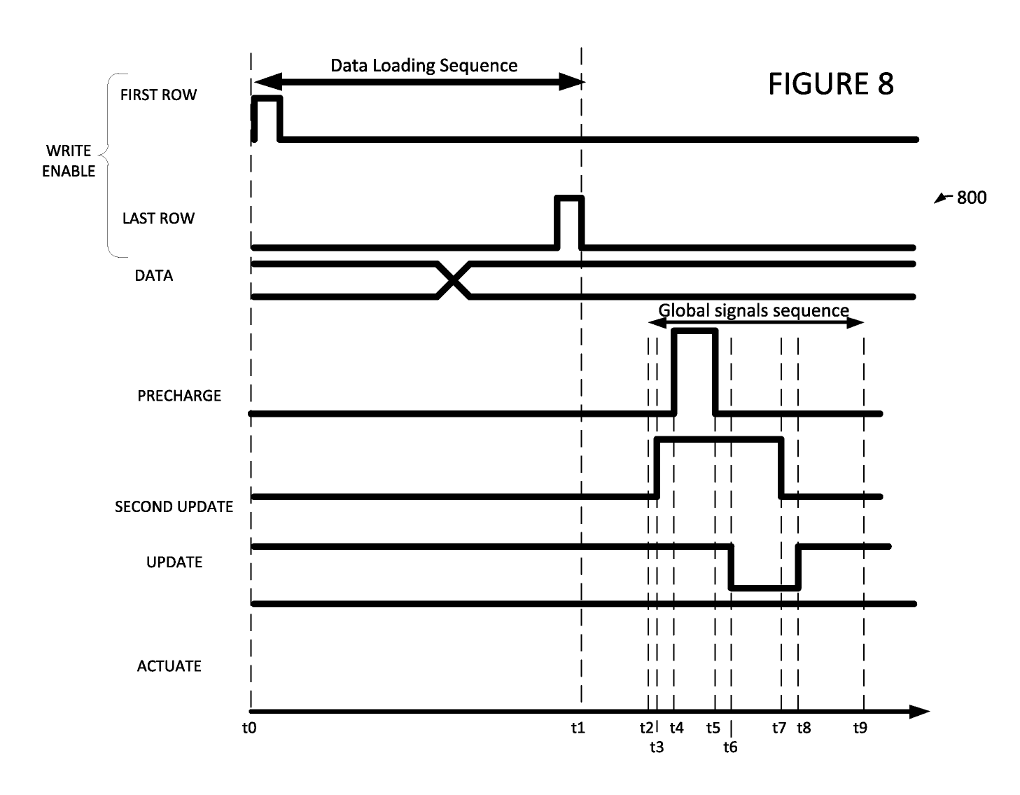

FIG. 7 is a flow diagram of an example process 700 of driving the pixel circuit 600 shown in FIG. 6. FIG. 8 is an example timing diagram 800 corresponding to the driving process 700 shown in FIG. 7. The process 700 is similar to the process 400 shown in FIG. 4. However, as the actuation interconnect 336 in the pixel circuit 600 is maintained at a substantially constant actuation voltage, the process 700 does not include stages for energizing the actuation interconnect (such as the stage 402 in FIG. 4) and de-energizing the actuation interconnect (such as the stage 420 in FIG. 4). Similarly, the waveform for the voltage on the actuation interconnect 336 (labeled “ACTUATE” in FIG. 8) shows that the actuation interconnect is maintained at a substantially constant actuation voltage.

Referring to FIGS. 6-8, the driving process 700 begins with loading data into the pixel circuits 600 of a display apparatus (stage 702), one row at a time, while the first update interconnect 338 is maintained at a high voltage and the voltages on the other common interconnects 334, 336, 338, 346 and 309 are kept low. An example data loading stage is shown from times t0 to t1 on the timing diagram 800.

The second update interconnect 346 is then brought high at time t3, preventing the second discharge switch 344 from being triggered prematurely (stage 706). A high voltage is then applied to the pre-charge interconnect 334 for a brief period of time (from time t4 to time t5) sufficient to bring the first and second output nodes 320 and 324 up to about the actuation voltage (less the threshold voltages of the first and second pre-charge switches 328 and 342) (stage 708).

The voltage on the first update interconnect 338 is then brought low at time t6, allowing the first discharge switch 332 to respond to the data voltage on the data store capacitor 310 (stage 710). A high voltage on the data store capacitor 310 turns on the first discharge switch 332, draining any voltage built up on the first update node 320. A low voltage on the data store capacitor 310 keeps the first discharge switch 332 off, maintaining about the actuation voltage on the first output node 320. At this stage, the voltage on the second output node 324 is still high, resulting in a first set of shutters actuating (stage 712). Specifically, all shutters that were previously drawn to the first output node 320 but for which the voltage on the first output node 320 has now drained, will be pulled toward the second output node 324.

After a sufficient amount of time has passed to allow the voltage to drain from the first output node 320 through the first discharge switch 332, at time t7 the voltage on the second update interconnect 346 is brought low (stage 714), allowing the second discharge switch 344 to be controlled by the voltage remaining on the first output node 320. If the voltage on the first output node 320 is low, the second discharge switch 344 remains OFF, maintaining the actuation voltage on the second output node 324. If the voltage on the first output node 320 is high, the second discharge switch 344 turns ON, releasing the voltage stored on the second output node 324. As a result, a second set of shutters actuate (stage 716). Specifically those shutters previously attracted to the second output node 324, but for which the voltage on the second output node 324 has now been released, are now free to be drawn towards the first output node 320. The voltage on the first update interconnect 338 is then raised again at time t8 (stage 718), preserving the states of the shutters until after the next data loading stage (stage 702).

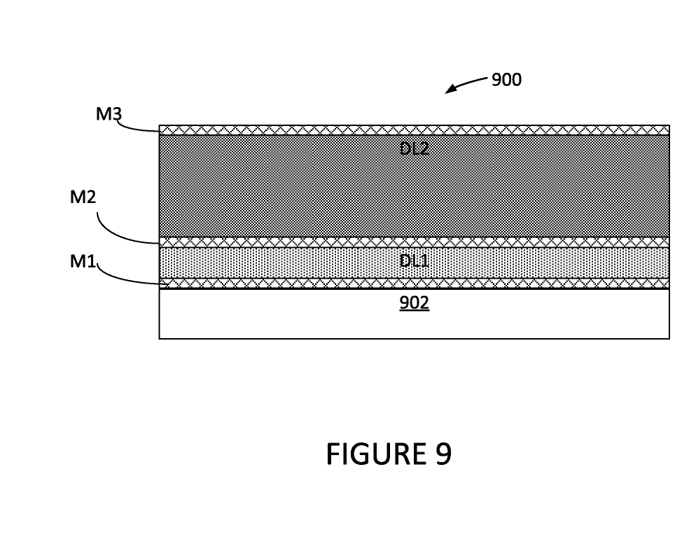

As mentioned above, the components of the pixel circuits 300 and 600 are dispersed among three different metal layers used to form the control matrix of a display apparatus. FIG. 9 is a cross-sectional diagram of an example schematic of the control matrix 900. The control matrix 900 is formed on one side a substrate 902. In some implementations, the other side of the substrate 902 serves as a coversheet for the display apparatus. In some other implementations, the other side of the substrate 902 faces a backlight, and a second substrate serves as the coversheet for the display apparatus.

The control matrix is formed from metal layers M1, M2 and M3. Each of the metal layers can be formed from aluminum (Al), titanium (Ti), or a transparent conductor, such as indium tin oxide (ITO). In some implementations, one or more metal layers (particularly the M3 layer) include multiple layers of a metal, such as a layer of A1 coated with ITO.

The metal layers are separated from one another by dielectric layers. A first dielectric layer DL1 separates the M1 layer from the M2 layer. A second dielectric layer DL2 separates the M2 layer from the M3 layer. In some implementations, DL2 takes the form of a planarization layer, and can be substantially thicker than the DL1. For example, DL2 can have a thickness that is between about 2 and about 10 times the thickness of DL1.

The greater thickness of DL2 allows for interconnects formed in the M3 layer to have lower levels of parasitic capacitance with respect to interconnects formed in the lower metal layers. As such, interconnects that consume the most power are formed in the M3 layer. For example, the data interconnects (DI) 305 of the pixel interconnect shown in FIGS. 3 and 6, may be switched once for every row of the display during each addressing cycle. Thus, even though the voltage swing on the data interconnects 305 may not be very large, the number of times that the voltage needs to be switched leads the data interconnects 305, in some implementations, to be responsible for more power consumption than other interconnects. In some implementations, the data interconnects 305 can be formed in the M3 layer. The pre-charge and shutter interconnects 334 and 309 also can be patterned into the M3 layer. In some implementations, the actuation voltage and first update interconnects 336 and 338 are patterned into the M2 layer and the write enable and second update interconnects 307 and 346, respectively, are patterned into the M1 layer. Forming DL2 from a planarization layer also has the advantage of providing a smooth flat surface upon which MEMS light modulators can be fabricated.

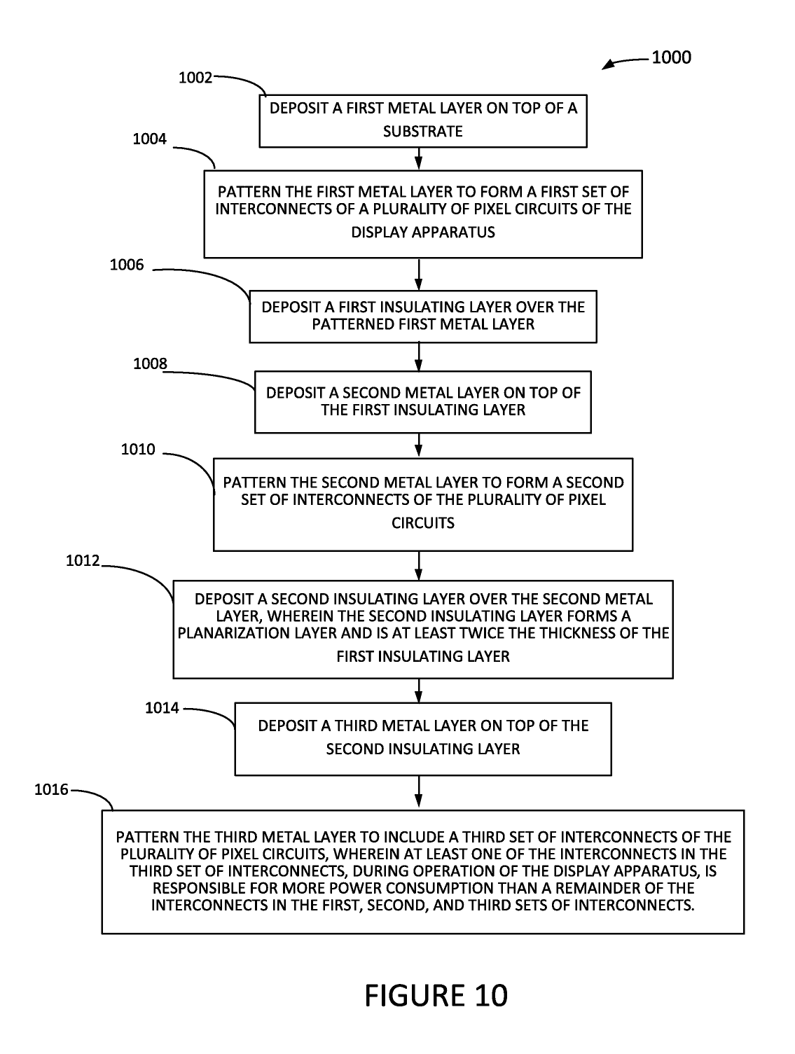

FIG. 10 is a flow diagram of an example process 1000 for fabricating a display apparatus. The process includes depositing a first metal layer on top of a substrate (stage 1002), patterning the first metal layer to form a first set of interconnects of a plurality of pixel circuits of the display apparatus (stage 1004), and depositing a first insulating layer over the patterned first metal layer (1006). The process 1000 also includes depositing a second metal layer on top of the first insulating layer (stage 1008), patterning the second metal layer to form a second set of interconnects of the plurality of pixel circuits (1010), and depositing a second insulating layer over the second metal layer (stage 1012). The second insulating layer forms a planarization layer and is at least twice the thickness of the first insulating layer. The process 1000 further includes depositing a third metal layer on top of the second insulating layer (stage 1014), and patterning the third metal layer to include a third set of interconnects of the plurality of pixel circuits (stage 1016). At least one of the interconnects in the third set of interconnects, during operation of the display apparatus, is responsible for more power consumption than a remainder of the interconnects in the first, second, and third sets of interconnects.

In some implementations, additional layers are deposited and patterned during the fabrication process 1000 to form components of the TFTs included in the pixel circuits shown in FIGS. 3 and 6. For example, certain conductive oxide (such as zinc oxide, indium gallium zinc oxide (IGZO), etc.) TFTs can be formed as bottom gate transistors. In such implementations, the gate terminals of the TFTs included in the pixel circuits 300 and 600 can be patterned into the M1 layer. The DL1 layer can be formed from two dielectric layers. A first gate dielectric is deposited directly on top of the patterned M1 layer. The active layer of the TFTs are then deposited and patterned on top of the gate dielectric. Another dielectric layer is then deposited on top of the patterned semiconductor layer. This dielectric layer is patterned at least to allow portions of the M2 layer (deposited on top of this dielectric layer) to contact the TFT channels patterned into the active semiconductor layer. The M2 layer includes the source drain terminals of the pixel circuit 300 TFTs.

In addition, in some implementations, an additional dielectric layer can be added on top of the M3 layer(s). In some implementations, one of the dielectric layers that makes up DL1 can be etched away when the corresponding layer is patterned in order to reduce the distance between the M1 and M2 layers, e.g., where interconnects in the M1 and M2 layer cross-over to form an intentional routing capacitance. Removing this intervening dielectric material can be used to adjust the magnitude of the intentional routing capacitance.

In some other implementations, the TFTs can be formed in a top gate configuration. In such implementations, the source and drain terminals of the TFTs are patterned into the M1 layer and the gate is patterned into the M2 layer. The active semiconductor channel is still deposited between two dielectric layers that make up the DL1 layer. The DL1 layer can still be made of the same dielectric layers used in the bottom gate configuration, but the order of their deposition with respect to the deposition of the active semiconductor layer may, in some implementations, be reversed. In some implementations, the DL1 layer can be formed by more than two different dielectric layers.

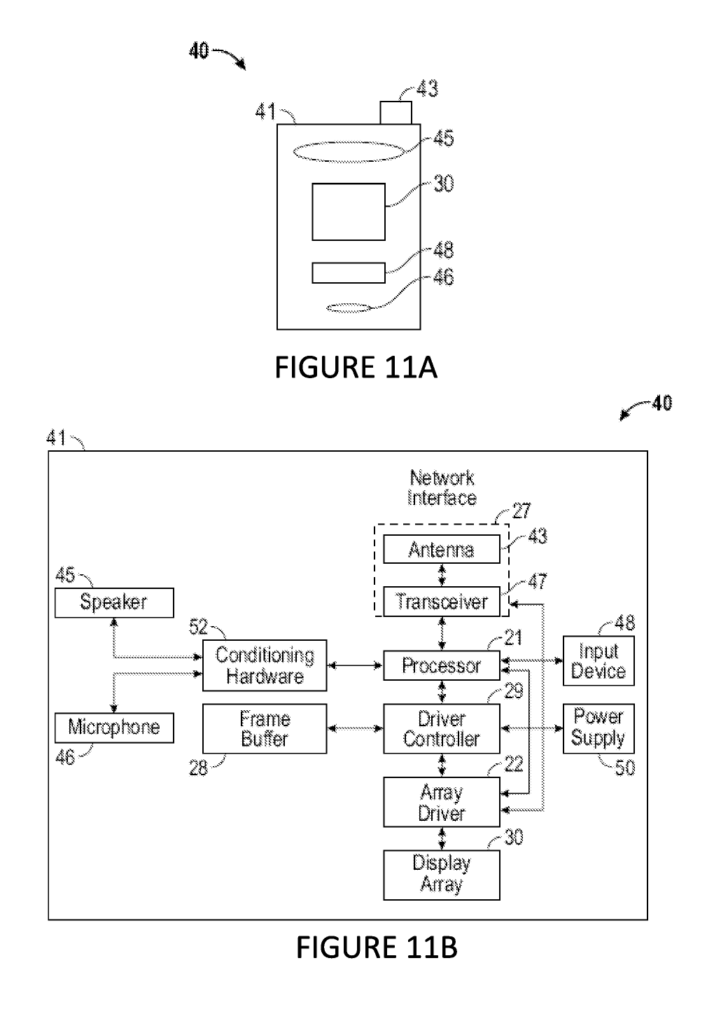

FIGS. 11A and 11B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 11B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 11A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display apparatus, comprising:
a plurality of light modulators;
an actuation interconnect for carrying an actuation voltage from one or more drivers to the plurality of light modulators;
a pixel circuit corresponding to each of the light modulators, each pixel circuit including:
a first actuation node, which when energized, causes a corresponding light modulator to enter or remain in a first state, wherein the first actuation node is coupled to the actuation interconnect with parallel connections via a first pre-charge switch and via a first capacitor; and
a second actuation node, which when energized, causes the corresponding light modulator to enter or remain in a second state, wherein the second actuation node is coupled to the actuation interconnect with parallel connections via a second first pre-charge switch and via a second capacitor.

2. The display apparatus of claim 1, wherein the actuation voltage on the actuation interconnect is a switched signal.

3. The display apparatus of claim 1, further including a data storage capacitor for storing a voltage corresponding to image data, wherein one terminal of the data storage capacitor is connected to the actuation interconnect.

4. The display apparatus of claim 3, wherein the actuation voltage on the actuation interconnect is substantially constant.

5. The display apparatus of claim 1, wherein each pixel circuit includes interconnects formed in each of at least three layers of metal deposited over a substrate.

6. The display apparatus of claim 5, wherein a distance between an upper-most metal layer of the three layers of metal is separated from a next nearest metal layer by a planarization layer, which is thicker than any lower level of dielectric.

7. The display apparatus of claim 6, wherein the planarization layer is between about 1.5 and about 3.5 microns thick.

8. The display apparatus of claim 1, wherein driving each of the interconnects consumes a respective amount of power and the interconnect responsible for consuming the greatest amount of power is formed in the uppermost metal layer.

9. The apparatus of claim 1, further comprising:
a display;
a processor capable of communicating with the display, the processor being capable of processing image data; and
a memory device capable of communicating with the processor.

10. The apparatus of claim 9, further comprising:
a driver circuit capable of sending at least one signal to the display; and
a controller capable of sending at least a portion of the image data to the driver circuit.

11. The apparatus of claim 9, further comprising:
an image source module capable of sending the image data to the processor, wherein the image source module includes at least one of a receiver, transceiver, and transmitter.

12. The apparatus of claim 9, further comprising:
an input device capable of receiving input data and communicating the input data to the processor.

13. A method for using a pixel circuit for actuating a light modulator, the light modulator having a shutter configured to move between a first actuator and a second actuator and the pixel circuit including a first output node coupled to the first actuator and a second output node coupled to the second actuator, comprising:
storing a data voltage in a data storage element of the pixel circuit;
charging the first output node and the second output node to an actuation voltage;
charging a reservoir capacitor coupled to each of the first output node and the second output node;
selectively discharging one of the first output node and the second output node based on the data voltage; and
providing charge to one of the first output node and the second output node, during an actuation of the light modulator, from the corresponding reservoir capacitor.

14. The method of claim 13, wherein storing a data voltage in the data storage element of the pixel circuit includes storing the charge in the data storage element having one terminal maintained at a constant actuation voltage.

15. The method of claim 13, wherein charging a reservoir capacitor coupled to each of the first output node and the second output node includes charging via an actuation voltage source.

16. The method of claim 13, wherein providing charge to one of the first output node and the second output node from the corresponding reservoir capacitor includes balancing a capacitive coupling between the first output node and the second output node.

17. An apparatus including a pixel circuit for actuating a light modulator having a shutter configured to move between a first actuator and a second actuator, comprising:
data storage means for storing a data voltage;
charging means for charging a first output node and a second output node of the pixel circuit to an actuation voltage, the first output node and the second output node coupled to the first actuator and a second actuator, respectively;
discharging means for selectively discharging one of the first output node and the second output node; and
reservoir charge storage means for providing charge to one of the first output node and the second output node during an actuation of the light modulator.

18. The apparatus of claim 17, wherein the data storage means include a data storage capacitor, one terminal of which is maintained at a constant actuation voltage.

19. The apparatus of claim 17, wherein the data storage means include a data storage capacitor, one terminal of which is maintained at a voltage equal to a voltage on the shutter.

20. The apparatus of claim 17, wherein the reservoir charge storage means are coupled to a voltage source providing the actuation voltage.
